(19) United States
(12) Patent Application Publication
(10) Pub. No.: US 2005/0095062 A1
(43) Pub. Date: May 5, 2005

(54) Clamp fastener and method of using a clamp fastener

(76) Inventors: Robert A. Iverson, Eden Prairie, MN (US); Rodney L. Bridges, Lilburn, GA (US)

Correspondence Address: Merchant & Gould P.C., P.O. Box 2903, Minneapolis, MN, 55402-0903, US

(21) Appl. No.: 10/698,852

(22) Filed: Oct. 31, 2003

(51) Int. Cl. F16B 2/02

(52) U.S. Cl. 403/374.3; 403/256

(57) ABSTRACT

A clamp fastener is provided including a first arm, a second arm, and a fastener member. The first arm includes a first arm clamping surface, an attachment region, a first arm rotation end, and a first arm tightening end. The attachment region can include a loop or ring for extending a tie down material therethrough. The second arm includes a second arm clamping surface, a second arm rotation end, and a second arm tightening end. The fastener can be provided for tightening and loosening the first arm tightening end relative to the second arm tightening end. The first arm rotation end and the second arm rotation end are constructed to rotatably engage each other to allow tightening of the first arm clamping surface and the second arm clamping surface about a clampable structure. In addition, the first arm rotation end and the second arm rotation end can be slidably engaged to allow assembly and disassembly of the clamp fastener by sliding the first arm and the second arm relative to each other. A method for using a clamp fastener is provided.

### FIELD OF THE INVENTION

The invention relates to a clamp fastener and to a method of using a clamp fastener. The clamp fastener can be used on motor vehicles to tie down a load.

### BACKGROUND OF THE INVENTION

Tie down materials such as ropes, straps, string, and bungee cords are often used to tie down a load on a motor vehicle. In the case of a motor vehicle such as a pickup truck having a bar extending over the pickup truck bed sidewalls, items can be 10 tied down or stabilized in the pickup truck bed by fastening a tie down material such as rope, string, straps, or bungee cord to the bar in order to hold the item in place. Unless the correct knot is used and/or the proper tension is applied, tie down materials have a tendency to slide along the bar. As a result, items that are tied down may have a tendency to shift during transport.

### SUMMARY OF THE INVENTION

A clamp fastener is provided according to the invention. The clamp fastener includes a first arm, a second arm, and a fastener member. The first arm includes a first arm clamping surface, an attachment region, a first arm rotation end, and a first arm tightening end. The attachment region can include a loop or ring for extending a tie down material therethrough. The second arm includes a second arm clamping surface, a second arm rotation end, and a second arm tightening end. The fastener can be provided for tightening and loosening the first arm tightening end relative to the second arm tightening end. The first arm rotation end and the second arm rotation end are constructed to rotatably engage each other to allow tightening of the first arm clamping surface and the second arm clamping surface about a clampable structure. In addition, the first arm rotation end and the second arm rotation end can be slidably engaged to allow assembly and disassembly of the clamp fastener by sliding the first arm and the second arm relative to each other.

A method for using a clamp fastener is provided according to the invention. The method can include steps of placing the first arm around a clampable structure so that the clamping surface is proximate the clampable structure, placing the second arm around the clampable structure offset from the first arm so that the second arm clamping surface is proximate the clampable structure, sliding the first arm rotation end and the second arm rotation end together to provide a rotation joint, and tightening the first arm and the second arm about the clampable structure by utilizing a fastener member for tightening the first arm tightening end relative to the second arm tightening end. It should be understood that the term “proximate” is intended to mean adjacent with the understanding that additional materials such as cushioning members can be provided between the surfaces. Tie down materials can be fastened to the attachment region.

### BRIEF DESCRIPTION OF THE DRAWING

FIG. 1 is a perspective view of the clamp fastener clamped about a clampable member according to the principles of the invention.

FIG. 2 is a perspective view of the clamp fastener of FIG. 1 shown partially assembled.

FIG. 3 is a side view of the clamp fastener of FIG. 1 without the fastener member.

### DEATAILED DESCRIPTION OF THE PREFERRED EMBODIMENT

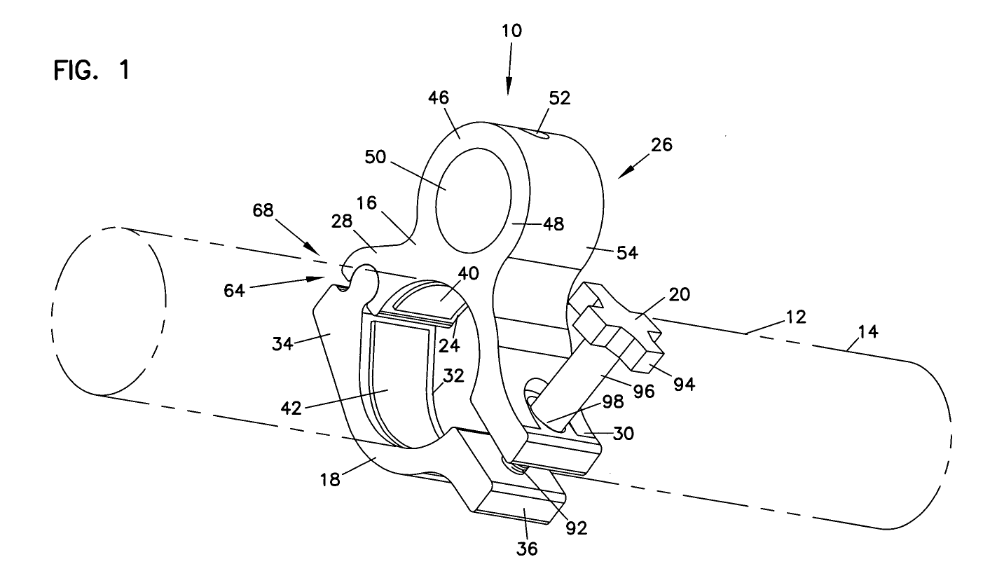

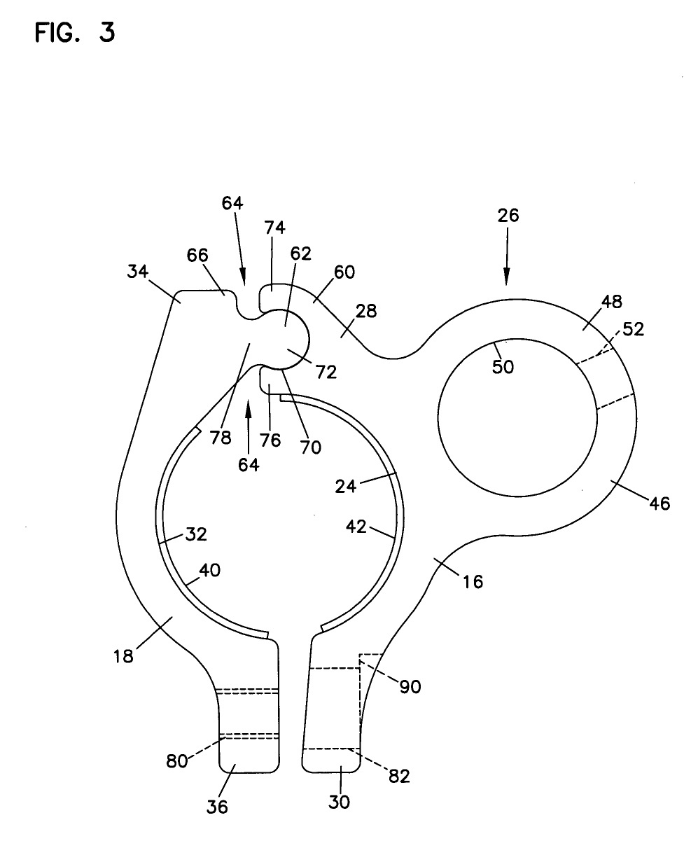

Referring to FIGS. 1-3, a clamp fastener according to the invention is shown at reference number 10. The clamp fastener 10 is shown in FIG. 1 attached about a clampable structure 12. The clampable structure can be any structure that allows the clamp fastener 10 to clamp thereto. An exemplary type of clampable structure 12 includes a pipe or bar 14. Exemplary pipes or bars can include those found on a pickup truck. For example, pickup trucks can include a pipe or bar that extends over the pickup truck bed. The clamp fastener 10 can be attached to the pipe or bar extending over a pickup truck bed or along a pickup truck bed sidewall as a rail, and can be used with tie down materials to hold items in place in the pickup truck bed. Exemplary tie down materials that can be used with the clamp fastener 10 include ropes, straps, string, line, and cords such as bungee cords. The clamp fastener 10 can be used in combination with the pickup truck bed frame described in U.S. application Ser. No.______ (attorney docket number 8338.232US01) that was filed with the United States Patent and Trademark Office on Oct. 31, 2003, the entire disclosure of which is incorporated herein by reference.

The clamp fastener 10 includes a first arm 16, a second arm 18, and a fastener member 20. The first arm 16 has a first arm clamping surface 24, an attachment region 26, a first arm rotation end 28, and a first arm tightening end 30. The second arm 18 includes a second arm clamping surface 32, a second arm rotation end 34, and a second arm tightening end 36.

The first arm clamping surface 24 and the second arm clamping surface 32 are provided with a configuration that allows the surfaces to enclose and fasten to the clampable structure 12. As shown in the figures, the first arm clamping surface 24 and the second arm clamping surface 32 are provided as curved surfaces to allow the clamp fastener 10 to fit around and engage the pipe or bar 14. It should be understood that different configurations can be provided. For example, the clamping surfaces 24 and 32 can be provided with a different configuration if the clampable structure 12 is provided with a different shape such as a rectangular or polygonal cross section. In addition, it should be understood that the clamping surfaces 24 and 32 need not be perfectly round. That is, the clamping surfaces 24 and 32 can have an oval or elongated shape in order to allow the clamp fastener 10 to fit around tubes having different sizes and to allow the clamp fastener 10 to better attach to the clampable structure 12.

The first arm clamping surface 24 and the second arm clamping surface 32 can include a first cushion member 40 and a second cushion member 42. In general, the first and second cushion members 40 and 42 are provided to reduce marring of the clampable structure 12 as a result of clamping the clamp fastener 10 thereto. The first and second cushion members 40 and 42 can be the same or different and can be any material that reduces marring on the clampable structure 12 and, preferably, resists slipping of the clamp fastener 10 relative to the clampable structure 12 when the clamp fastener 10 is attached. That is, during operation, it is generally desirable for the clamp fastener 10 to be attached to the clampable structure 12 and remain attached without sliding along the clampable structure 12 while in use. Exemplary types of materials that can serve as the first and second cushion members 40 and 42 include form, rubber, plastic, etc. Furthermore, the first and second cushion members 40 and 42 can be adhered to the first arm clamping surface 24 and the second arm clamping surface 32, respectively, by adhesive, glue, tape, etc. The first and second cushion members 40 and 42 can be characterized as self-adhesive when they include an adhesive layer that allows them to attach and adhere to the clamping surfaces 24 and 32. Furthermore, although the first and second cushion members 40 and 42 are shown as continuous sheets, they can be provided as a series of discrete pieces or perforated or holed structures that allow coverage of a desired amount of the first arm clamping surface 24 and the second arm clamping surface 32.

The first arm attachment region 26 is provided to allow attachment of tie down materials thereto. The attachment region 26 includes an attachment loop 46 that is provided as a ring 48 having an opening 50. Tie down materials can pass through the opening 50 to secure items in place. Exemplary tie down materials include rope, string, straps, lines, bungee cords, etc. The ring 48 can be constructed having an enclosed opening 50 or there can be a gap in the wall 54 of the ring 48 to provide a post or hook to which a loop of tie down material can be fastened. The ring 48 is advantageous because the tie down material can be tied thereto and will not slip off as long as the knot holds and as long as the tie down material does not fail. A secondary opening 52 can be provided in the wall 54 of the ring. The secondary opening 52 can be used to assist in fastening tie down materials to the ring 48. For example, rope and string can pass through the secondary opening 52 and through the opening 50 and tied off. Furthermore, the secondary opening 52 can be sized to allow for utilizing a hook for attachment thereto. For example, the hook on a bungee cord can pass through the secondary opening 52 and hook between the secondary opening 52 and the opening 50.

The first arm rotation end 28 and the second arm rotation end 34 are constructed to engage each other in a manner that resists separation when the clamp fastener 10 is engaged and tightened around the clampable structure 12. As shown in FIGS. 1-3, the first arm rotation end 28 includes a female coupling member 60, and the second arm rotation end 34 includes a male coupling member 62. It should be understood that this arrangement can be reversed. For example, the first arm rotation end 28 can include the male coupling member and the second arm rotation end 34 can include the female coupling member. The combination of the female coupling member 60 and the male coupling member 62 provides a rotation joint 64 that allows rotation of the first arm 16 relative to the second arm 18. The rotation can be referred to as rotation limited because the second arm rotation end 34 includes a rotation stop 66 that prevents rotation beyond a certain point. The extend of the limit to rotation can be sufficient so that the first arm tightening end 30 and the second arm tightening end 36 are not capable of separating enough to allow the clamp fastener 10 to fit over the clampable structure 12 without separating the first arm 16 and the second arm 18. In addition, it should be understood that the rotation stop 66 can be moved further back or can be removed all together so that the extended rotation between the first arm 16 and the second arm 18 can be increased to allow the clamp fastener 10 to fit over the clampable structure 12 without disassembly.

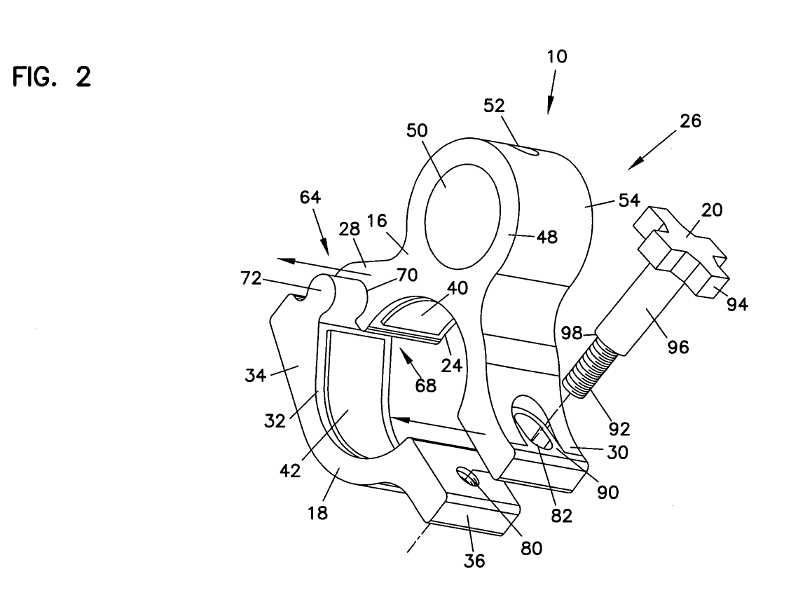

The female coupling member 60 and the male coupling member 62 can engage in a manner that allows sliding movement of the first arm 16 relative to the second arm 18 as shown in FIG. 2. Accordingly, the connection between the first arm rotation end 28 and the second arm rotation end 34 can be referred to as a slide joint 68.

The slide joint 68 allows the first arm 16 and the second arm 18 to engage and/or 25 disengage each other by sliding in the direction of the arrow in FIG. 2 (or in the reverse direction).

The clamp fastener 10 can be attached to the clampable structure 12 by first providing the first arm 16 and the second arm 18 as separated from each other.

One of the first arm 16 and the second arm 18 can be placed around the clampable 30 structure 12, and the remaining arm can then be placed around the clampable structure 12 and offset from the other of the first arm 16 and the second arm 18. The first arm 16 and the second arm 18 can slidingly engage each other along the slide joint 68. The fastener member 20 can then be used to tighten the first arm tightening end 30 relative to the second arm tightening arm 36 to provide a clamping action on the clampable structure 12.

The female coupling member 60 is shown as a groove 70 through which the head 72 on the male coupling member 62 can be provided. The groove 70 can be structured so that the head 72 can slide through the groove 70 but cannot pull away from it when it is engaged within the groove. That is, the groove 70 can be provided so that it encircles the head 72 to an extent sufficient to prevent the head 72 from pulling out of the groove 70 except along the direction of the arrow (or the reverse direction) shown in FIG. 2. The direction of the arrow in FIG. 2 can be referred to as the sliding direction or the extrusion/machine direction. The perpendicular direction to the arrows shown in FIG. 2 can be referred to as the transverse direction and the groove 70 can be provided so that it prevents the head 72 from moving in the transverse direction. It is understood that if the groove 70 encircles the head 72 too much, there will be a reduction in the amount of rotation available between the first arm 16 and the second arm 18. The portions of the groove 70 that encircle the head 72 can be referred to as the first groove arm 74 and the second groove arm 76. The portion of the second arm 18 that permits the first groove arm 74 and the second groove arm 76 to move around the head 72 can be referred to as the neck 78. It should be understood that the neck 78 has a width that is sufficient to allow the first groove arm 74 and the second groove arm 76 to move around the head 72 to provide rotation. In addition, the spacing between the first groove arm 74 and the stop 66 should be sufficient to allow a desired amount of rotation.

The first arm tightening end 30 and the second arm tightening end 36 include fastener openings 80 and 82. The fastener member 20 passes through the fastener openings 80 and 82. The opening 80 can include threads 84 to allow tightening of the fastener member 20. The opening 82 can be provided without any threads and tightening vis-à-vis fastener member 20 can be provided as a result of the fastener member 20 pressing against the seating surface 90. Various types of fastener members can be utilized to tighten the first arm tightening end 30 relative to the second arm tightening end 36. The fastener member 20 can be a bolt 92 that passes through the opening 82 and engages the threads 84 in the opening 80 to provide tightening. The bolt 92 can be provided having a knob 94 to assist with hand tightening. In addition, a knob extension 96 can be provided to help move the knob 94 away from the seating surface 90 to allow a user to utilize his or her hands more easily to turn the knob 94 without encountering obstruction from the remainder of the clamp fastener 10. In addition, the knob extension 96 can include a bottom surface 98 that engages the seating surface 90 and applies pressure against the seating surface 90 to cause compression of the first arm 16 and the second arm 18 about the clampable structure 12. It should be understood that the configuration of the openings 80 and 82 can be reversed. That is, the first arm 16 can include a threaded opening, and the knob on the fastener member can be provided on the side of the second arm 18. That is, the openings 80 and 82 can be reversed. Furthermore, it should be understood that alternative arrangements for tightening the first arm tightening end 30 relative to the second arm tightening end 36 can be provided. For example, a nut and bolt fastener arrangement can be provided. In this arrangement, openings 80 and 82 can both be provided without threads.

The first arm 16 and the second arm 18 can be manufactured by various techniques including extrusion. Extrusion is a convenient technique for manufacturing the first arm 16 and the second arm 18 because each arm can be separately extruded and cut to provide the desired width. Exemplary extrusion materials that can be used to form the clamp fastener include aluminum and plastic. In the case of using plastic, it is expected that various types of plastic can be utilized including, for example, polyethylene and polypropylene, and filler reinforced plastics such as glass reinforced plastic. The width of the clamp fastener can be provided with any width that is convenient and provides the desired amount of clamping. In the case of a clamp fastener manufactured from aluminum, the width can be about 1 inch.

The above specification, examples and data provide a complete description of the manufacture and use of the composition of the invention. Since many embodiments of the invention can be made without departing from the spirit and scope of the invention, the invention resides in the claims hereinafter appended.

1. A clamp fastener comprising:
(a) a first arm having a first arm clamping surface, an attachment region, a first arm rotation end, and a first arm tightening end, wherein the attachment region comprises a loop for extending a tie down material therethrough;
(b) a second arm having a second arm clamping surface, a second arm rotation end, and a second arm tightening end;
(c) a fastener member constructed for tightening and loosening the first arm tightening end relative to the second arm tightening end; and
(d) the first arm rotation end and the second arm rotation end are constructed to rotatably engage each other to allow tightening of the first arm clamping surface and the second arm clamping surface about a clampable structure.

2. A clamp fastener according to claim 1, further comprising a first cushioning member adhered to the first arm clamping surface, and a second cushioning member adhered to the second arm clamping surface.

3. A clamp fastener according to claim 1, wherein the first arm rotation end and the second arm rotation end are constructed to slidingly engage each other to provide for attachment of the first arm to the second arm and detachment of the first arm from the second arm.

4. A clamp fastener according to claim 1, wherein the attachment region comprises a secondary hole extending through the loop.

5. A clamp fastener according to claim 1, wherein the fastener member comprises a bolt and a knob, wherein the bolt comprises threads that engage a threaded hole in at least one of the first arm tightening end and second arm tightening end.

6. A clamp fastener according to claim 1, wherein the first arm rotation end comprises a groove, and the second arm rotation end comprises a head that engages the groove.

7. A clamp fastener according to claim 1, wherein the first arm and the second arm are a result of extrusion.

8. A clamp fastener according to claim 7, wherein the first arm and the second arm comprise aluminum.

9. A clamp fastener according to claim 1, wherein the second arm rotation end comprises a stop that prevents rotation.

10. A method of using a clamp fastener comprising:
(a) placing a first arm around a clampable structure, wherein the first arm includes a first arm clamping surface, an attachment region, a first arm rotation end, and a first arm tightening end, and the clamping surface is provided around the clampable structure;
(b) placing a second arm around the clampable structure offset from the first arm, wherein the second arm comprises a second arm clamping surface, a second arm rotation end, and a second arm tightening end, and wherein the second arm clamping surface is proximate the clampable structure;
(c) sliding the first arm rotation end and the second arm rotation end together to provide a rotation joint; and
(d) tightening the first arm and the second arm about the clampable structure by utilizing a fastener member for tightening the first arm tightening end relative to the second arm tightening end.

11. A method according to claim 10, wherein the step of tightening comprises hand tightening by turning a knob provided on the fastener member.

12. A method according to claim 10, wherein the first arm clamping surface includes a first cushioning member adhered thereto, and the second arm clamping surface comprises a second cushioning member adhered thereto.

13. A method according to claim 10, wherein the attachment region comprises a secondary hole extending through the loop.

14. A method according to claim 10, further comprising providing a tie down material through the opening.

15. A method according to claim 14, wherein the tie down material comprises at least one of rope, line, a strap, and string.

16. A method according to claim 14, further comprising applying a tie down material through the secondary opening.

17. A method according to claim 16, wherein the tie down material comprises a hook attached to a bungee cord.
